(19) United States
(12) Patent Application Publication
(10) Pub. No.: US 2023/0400975 A1
(43) Pub. Date: Dec. 14, 2023

(54) THERMAL MANAGEMENT OF AN ELECTRONIC DEVICE

(71) Applicant: QUALCOMM Incorporated, San Diego, CA (US)

(72) Inventors: Naga Chandan Babu GUDIVADA, Hyderabad (IN); Rakesh PALLERLA, Hyderabad (IN); Prakash TIWARI, Hyderabad (IN)

(21) Appl. No.: 17/838,403

(22) Filed: Jun. 13, 2022

(51) Int. Cl. G06F 3/04847; G06F 3/0482; G06F 3/01

(52) U.S. Cl. CPC G06F 3/04847; G06F 3/017; G06F 3/0482

(57) ABSTRACT

Systems, methods, and non-transitory media are provided for managing thermal profiles for an electronic device. For example, a method may include setting an electronic device to first thermal profile based on a first context, receiving a context change indicating that the electronic device is associated with a second context and, based on the second context, setting the electronic device to a second thermal profile. The setting of the electronic device to the second thermal profile can occur in an interactive mode in which user input is received or a non-interactive mode in which the electronic device automatically selects the second thermal profile.

### TECHNICAL FIELD

The present disclosure generally relates to thermal management for an electronic device and a graphical user interface for managing thermal configuration for the electronic device.

### BACKGROUND

Electronic devices are used in different forms of communication including business applications, gaming applications, and social media interactions. The energy and processing demands of electronic devices can vary based on the context or mode in which it is used. Electronic devices may suffer from power and thermal issues, such as due to the adoption of high-frequency multi-core processors that generate heat. Techniques for resolving the thermal problems in mobile environments are only as good as the thermal profiling that can be performed for the respective device.

### SUMMARY

Systems and techniques are described herein that provide thermal management of electronic devices. According to at least one example, a method is provided for maintaining thermal profiles. The method includes: setting an electronic device to first thermal profile based on a first context associated with the electronic device; receiving a context change indicating that the electronic device is associated with a second context; and based on the second context, setting the electronic device to a second thermal profile.

In another example, an apparatus for maintaining thermal profiles is provided that includes at least one memory and at least one processor (e.g., configured in circuitry) coupled to the at least one memory. The at least one processor is configured to: set the apparatus to first thermal profile based on a first context associated with the apparatus; receive a context change indicating that the apparatus is associated with a second context; and based on the second context, set the apparatus to a second thermal profile.

In another example, a non-transitory computer-readable medium of an electronic device is provided that has stored thereon instructions that, when executed by one or more processors, cause the one or more processors to: set the electronic device to first thermal profile based on a first context associated with the electronic device; receive a context change indicating that the electronic device is associated with a second context; and based on the second context, set the electronic device to a second thermal profile.

In another example, an apparatus for maintaining thermal profiles is provided. The apparatus includes: means for setting an apparatus to first thermal profile based on a first context associated with the apparatus; means for receiving a context change indicating that the apparatus is associated with a second context; and based on the second context, means for setting the apparatus to a second thermal profile.

In some aspects, one or more of the apparatuses described herein is, is part of, and/or includes a mobile device (e.g., a mobile telephone or other mobile device), a wearable device, an extended reality (XR) device (e.g., a virtual reality (VR) device, an augmented reality (AR) device, or a mixed reality (MR) device), a head-mounted device (HMD) device, a wireless communication device, a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an electronic device used to adjust thermal profiles based on a change in context or use of the electronic device, in accordance with some examples of the present disclosure;

FIG. 2A is a diagram illustrating an example interactive graphical user interface in which the user can select or confirm a new thermal profile for the electronic device, in accordance with some examples of the present disclosure;

FIG. 2B, FIG. 2C, and FIG. 2D are diagrams illustrating examples of graphical user interfaces, in accordance with some examples of the present disclosure;

FIG. 2E is a diagram illustrating an example user input in which a user can interact with a quick panel button or object on a graphical user interface to establish a temperature setting for an application, in accordance with some examples of the present disclosure;

FIG. 3 is a flowchart illustrating an example process for changing or updating a thermal profile of an electronic device, in accordance with some examples of the present disclosure;

FIG. 4 is a diagram illustrating an example of an electronic device configured to obtain various types of input for changing or adjusting a thermal profile for the electronic device, in accordance with some examples of the present disclosure;

FIG. 5 is a flowchart illustrating an example process for changing or adjusting a thermal profile for an electronic device, in accordance with some examples of the present disclosure; and

FIG. 6 illustrates an example computing device architecture, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices can include mobile devices (e.g., mobile phones), wearable devices (e.g., smart watches, smart glasses, etc.), tablet computers, extended reality (XR) devices (e.g., virtual reality (VR) devices, augmented reality (AR) devices, mixed reality (MR) devices), connected devices, laptop computers, among other devices. An electronic device (e.g., a mobile phone, etc.) is configured with hardware components that enable the electronic device to perform or execute a particular context or application. For instance, an electronic device (e.g., a mobile device or XR device such as a head-mounted display or HMD) can include a structure that allows a user to position the mobile device/XR device in front of the user's eyes for a VR experience. The electronic device can implement cameras to capture images or video frames of a scene including various items, such as person(s), animal(s), and/or any object(s). The electronic device may have one or more sensors that can sense various conditions such as an orientation of the electronic device, a location, a temperature, a humidity, an elevation, etc. Other sensors may include a sensor for facial recognition, fingerprint recognition, heat sensors, motion or gesture recognition, and so forth.

The electronic device may operate at different temperatures depending on the use or the context in which the device is operating. For example, one respective application being run by the electronic device may cause or generate more heat than another application. An electronic device having a certain temperature may be more painful or potentially damaging to a user's body when held up to the user's eyes or an ear in contrast to being held in the user's hand. The way the electronic device is used may also impact body parts differently. Moreover, high temperatures of the device and/or high temperatures of components within the device can affect the integrity and the physical connections of the components, resulting in degraded performance or failure of the components altogether.

In some cases, upon detecting a temperature greater than a temperature or thermal threshold, the electronic device can execute thermal mitigation procedures to mitigate the undesirable results that can occur due to excessive heat within the system of the device. A single default temperature threshold setting for a device may be workable for the hardware components of the electronic device to keep them from being damaged. However, there are many different contexts or uses for electronic devices that may not all be appropriate for one single default thermal profile. Furthermore, if the temperature threshold is not adjusted for an electronic device, high temperatures can cause harm to a user of the electronic device.

Systems, apparatuses, electronic devices, methods (also referred to as processes), and computer-readable media (collectively referred to herein as “systems and techniques”) are described herein for providing management of thermal profiles associated with an electronic device. In some aspects, the systems and techniques may determine a context in which an electronic device is being used and may adjust or set a temperature threshold (which also may be referred to as a thermal threshold) or a thermal profile for the electronic device. In some cases, the systems and techniques can adjust the temperature threshold or the thermal profile for the electronic device based on a usage mode of the electronic device (e.g., a first mode related to extended reality versus a second mode related normal use of the electronic device in a user's hand) and/or based on user input provided by a user of the electronic device via a graphical user interface. For example, the systems and techniques can make changes to the thermal profile automatically or based on the display or presentation of an interactive graphical user interface that enables the user to provide input to choose or confirm the context and/or a new thermal profile.

A particular thermal profile may include or be associated with a particular temperature threshold and may include thermal mitigation techniques that can be performed to allow the electronic device to reach the particular temperature threshold. An example of such thermal mitigation techniques may include usage or non-usage of certain hardware components (e.g., temporarily ceasing usage of a high-power processor until the temperature reduces below the temperature threshold by a certain amount), reduction in usage of certain hardware components (e.g., temporarily reduced processing speeds of one or more hardware components), reduced functionality of the device, any combination thereof, and/or other thermal mitigation techniques.

The systems and techniques may manage the thermal profiles of an electronic device such that a different temperature threshold can be provided for different contexts of the electronic device. In some examples, an electronic device can select or set a thermal profile (e.g., associated with an associated temperature threshold) from a plurality of different thermal profiles based on operating conditions of the electronic device. In one illustrative example, the electronic device can be used in a context of VR in which the electronic device is used in close proximity to the eyes of the user. Because the user's eyes would be closer to the electronic device in the VR context, the eyes would be more exposed to high temperatures generated by the electronic device. The hands, in contrast to the eyes or the ears of a user, can sustain or accommodate higher temperatures. Thus, when the electronic device is used for a VR experience, a thermal profile can be selected or set which is configured to reduce the thermal exposure (and thus have a lower temperature threshold) to the user's eyes relative to other thermal profiles or a default thermal profile.

As the electronic device transitions from one use or application (e.g., from a VR context) to another use or application (e.g., to a phone call context, a gaming context, etc.), the electronic device can detect a context change for the electronic device and can select a different thermal profile (and corresponding temperature threshold) in order to increase or decrease the temperature of the electronic device. The allowable increase in temperature can allow the electronic device to increase performance, such as by allowing higher usage of certain hardware components. In some aspects, any change in the thermal profile would generally result in a temperature threshold that is below a maximum temperature junction Tj.

Various aspects of the application will be described with respect to the figures.

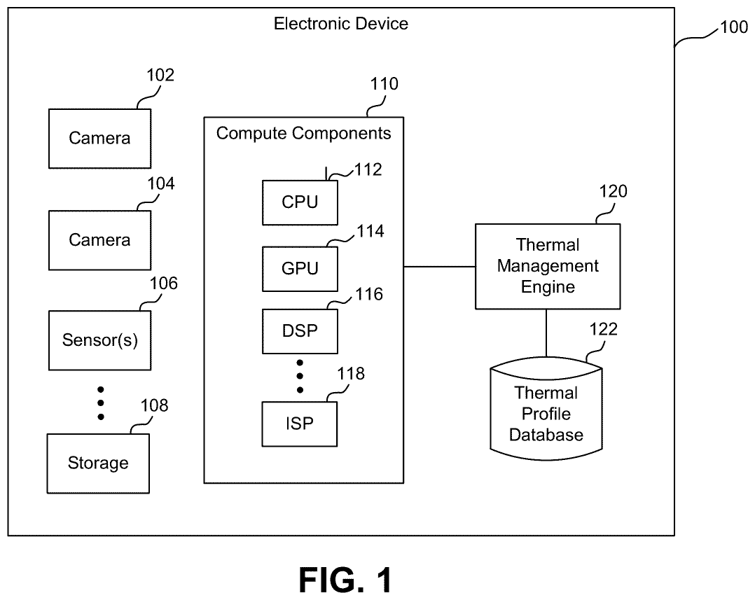

FIG. 1 is a diagram illustrating an example of an electronic device 100 that is configured to adjust thermal profile settings based on a change in context or based on other factors, as further described herein. In some aspects, the electronic device 100 can be configured to perform one or more functionalities such as, for example, imaging functionalities, image data segmentation functionalities, detection functionalities (e.g., object detection, pose detection, face detection, shape detection, scene detection, motion detection, etc.), image processing functionalities, extended reality (XR) functionalities (e.g., localization/tracking, detection, classification, mapping, content rendering, etc.), device management and/or control functionalities, gaming functionalities, computer vision, robotic functions, automation, and/or any other computing functionalities.

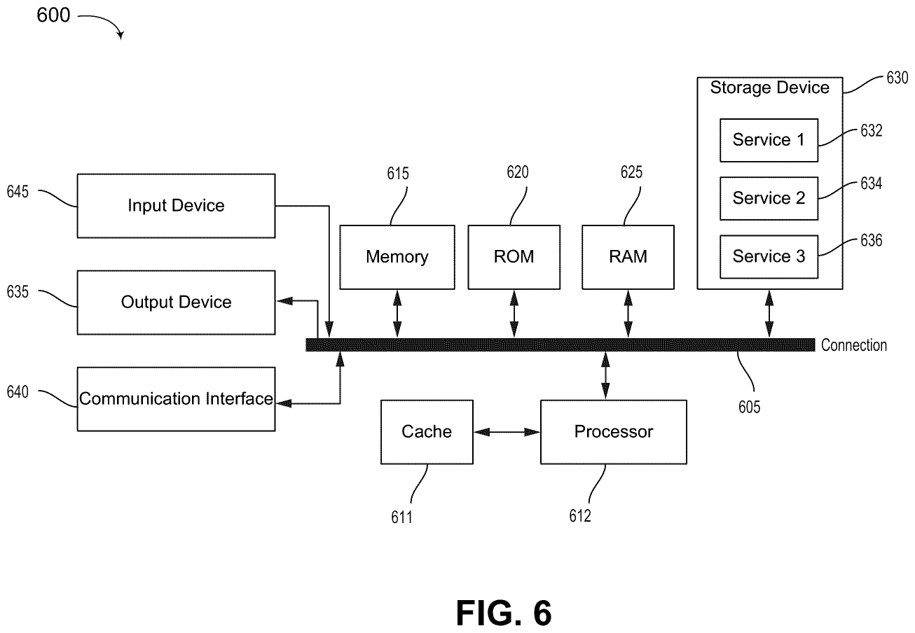

In the illustrative example shown in FIG. 1, the electronic device 100 can include one or more camera devices, such as camera 102 and camera 104, one or more sensors 106 (e.g., an ultrasonic sensor, an inertial measurement unit, a depth sensor using any suitable technology for determining depth (e.g., based on time-of-flight (ToF), structured light, or other depth sensing technique or system), a touch sensor, a microphone, a thermometer, etc.), a storage 108, one or more compute components 110, a thermal management engine 120, and a thermal profile database 122. In some cases, the electronic device 100 can optionally include one or more other/additional sensors such as, for example and without limitation, a pressure sensor (e.g., a barometric air pressure sensor and/or any other pressure sensor), a gyroscope, an accelerometer, a magnetometer, a thermometer, and/or any other sensor. A sensor can be included to capture motion or gestures of a user's hand or other body part in the air or gestures provided on a touch-sensitive display. In some examples, the electronic device 100 can include additional components such as, for example, a light-emitting diode (LED) device, a cache, a communications interface, a display, a memory device, etc. An example architecture and example hardware components that can be implemented by the electronic device 100 are further described below with respect to FIG. 6.

The electronic device 100 can be part of, or implemented by, a single computing device or multiple computing devices. In some examples, the electronic device 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a laptop or notebook computer, a tablet computer, a set-top box, a smart television, a display device, a gaming console, an XR device such as a head-mounted device (HMD) that can perform virtual reality (AR), augmented reality (AR), or mixed reality (MR) functionality, an IoT (Internet-of-Things) device, a smart wearable device, or any other suitable electronic device(s).

In some implementations, the camera 102, the camera 104, the one or more sensors 106, the storage 108, the one or more compute components 110, the thermal management engine 120, and/or the thermal profile database 122 can be part of the same computing device. For example, in some cases, the camera 102, the camera 104, the one or more sensors 106, the storage 108, the one or more compute components 110, the thermal management engine 120, and/or the thermal profile database 122 can be integrated with or into a camera system, a smartphone, a laptop, a tablet computer, a smart wearable device, an XR device such as an HMD, an IoT device, a gaming system, and/or any other computing device. In other implementations, the camera 102, the camera 104, the one or more sensors 106, the storage 108, the one or more compute components 110, the thermal management engine 120, and/or the thermal profile database 122 can be part of, or implemented by, two or more separate computing devices.

The one or more compute components 110 of the electronic device 100 can include, for example and without limitation, a central processing unit (CPU) 112, a graphics processing unit (GPU) 114, a digital signal processor (DSP) 116, and/or an image signal processor (ISP) 118. In some examples, the electronic device 100 can include other processors or processing devices such as, for example, a computer vision (CV) processor, a neural network processor (NNP), an application-specific integrated circuit (ASIC), a field-programmable gate array (FPGA), etc. The electronic device 100 can use the one or more compute components 110 to perform various computing operations such as, for example, posture mode functionalities as described herein, extended reality operations (e.g., tracking, localization, object detection, classification, pose estimation, mapping, content anchoring, content rendering, etc.), detection (e.g., face detection, object detection, scene detection, human detection, etc.), image segmentation, automatic posture correction, device control operations, image/video processing, graphics rendering, machine learning, data processing, modeling, calculations, computer vision, and/or any other operations. Depending on the context, these various components may generate different levels of heat (e.g., as governed via a particular thermal profile).

In some cases, the one or more compute components 110 can include other electronic circuits or hardware, computer software, firmware, or any combination thereof, to perform any of the various operations described herein. In some examples, the one or more compute components 110 can include more or less compute components than those shown in FIG. 1. Moreover, the CPU 112, the GPU 114, the DSP 116, and the ISP 118 are merely illustrative examples of compute components provided for explanation purposes. As noted above, depending on the type of hardware used at any given point in time, the various components may generate different levels of heat. In some cases, the generation of the heat can be governed by a particular thermal profile from the thermal profile database 122 (which in some cases may include a default thermal profile set by the manufacturer of the electronic device 100). A selected thermal profile can specify which compute components are used and how the compute components are used (e.g., using a standard or reduced processing speed, at a reduced functionality, etc.) to operate the electronic device 100. The thermal profile can also indicate one or more temperature thresholds (e.g., a minimum and/or maximum temperature threshold) at which the electronic device 100 (and its components) can operate. Details regarding selection of a thermal profile by the thermal management engine 120 are described below.

The camera 102 and/or the camera 104 can include any image and/or video sensor and/or image/video capture device, such as a digital camera sensor, a video camera sensor, a smartphone camera sensor, an image/video capture device on an electronic apparatus such as a television or computer, a camera, etc. In some cases, the camera 102 and/or the camera 104 can be part of a camera system or computing device such as a digital camera, a video camera, an IP camera, a smartphone, a smart television, a game system, etc. Moreover, in some cases, the camera 102 and the camera 104 can include multiple image sensors, such as rear and front sensor devices, and can be part of a dual-camera or other multi-camera assembly (e.g., including two camera, three cameras, four cameras, or other number of cameras). In some examples, the camera 102 and/or the camera 104 can be part of a camera. In some cases, different thermal profiles might apply based on a configuration of the camera 102 and/or the camera 104, a number of cameras that are being used, how data received from the camera 102 and/or the camera 104 is processed. For example, the thermal management engine 120 may analyze data received from a camera 102/104 at least in part to evaluate a context of the electronic device for changing a thermal profile.

The storage 108 can include any storage device(s) for storing data such as, for example and without limitation, image data, posture date, scene data, user data, preferences, etc. The storage 108 can store data from any of the components of the electronic device 100. For example, the storage 108 can store data or measurements from any of the cameras 102 and 104, the one or more sensors 106, the compute components 110 (e.g., processing parameters, outputs, video, images, segmentation maps/masks, depth maps, filtering results, calculation results, detection results, posture correction data, etc.), the thermal management engine 120, the thermal profile database 122, and/or any other components. In some examples, the storage 108 can include a buffer for storing data (e.g., various thermal profiles) for processing by the compute components 110. In the example of FIG. 1, the thermal profile database 122 is part of the electronic device 100. In some examples, the thermal profile database 122 can be part of the storage 108. In some cases, the thermal profile database 122 can be located remotely from the electronic device 100 (e.g., the thermal profile database 122 can be included in one or more cloud-based servers). In such cases, the electronic device 100 may access the thermal profile database 122 via a wired or wireless network.

The thermal management engine 120 can implement one or more algorithms and/or machine learning models configured to implement the dynamic adjustment of thermal profile settings as described herein. In the example of FIG. 1, the thermal management engine 120 is part of the electronic device 100. In some cases, the thermal management engine 120 can be located remotely from the electronic device 100 (e.g., the thermal management engine 120 can be included in one or more cloud-based servers). In such cases, the thermal management engine 120 can communicate with the electronic device 100 via a wired or wireless network.

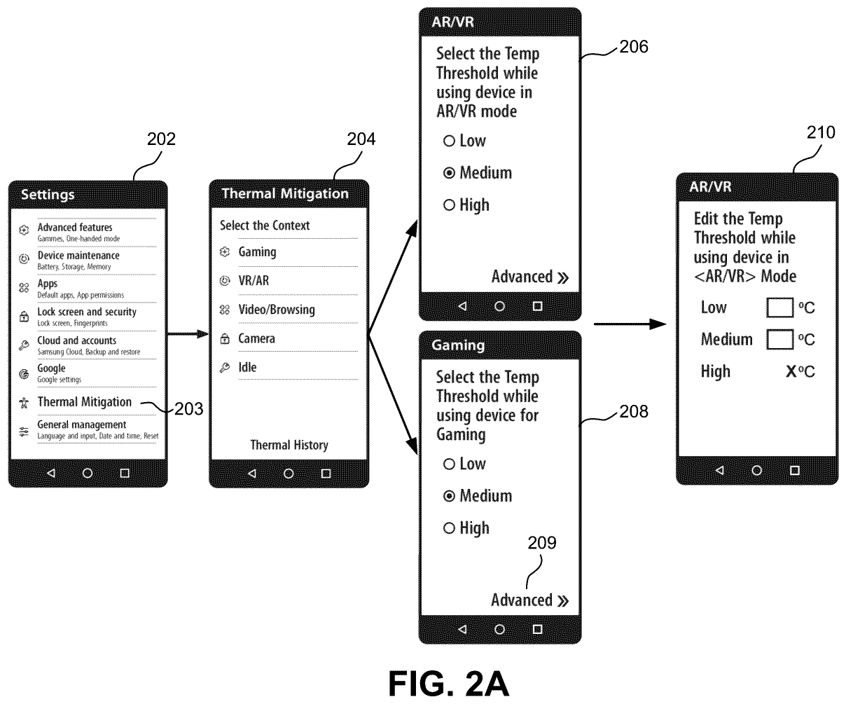

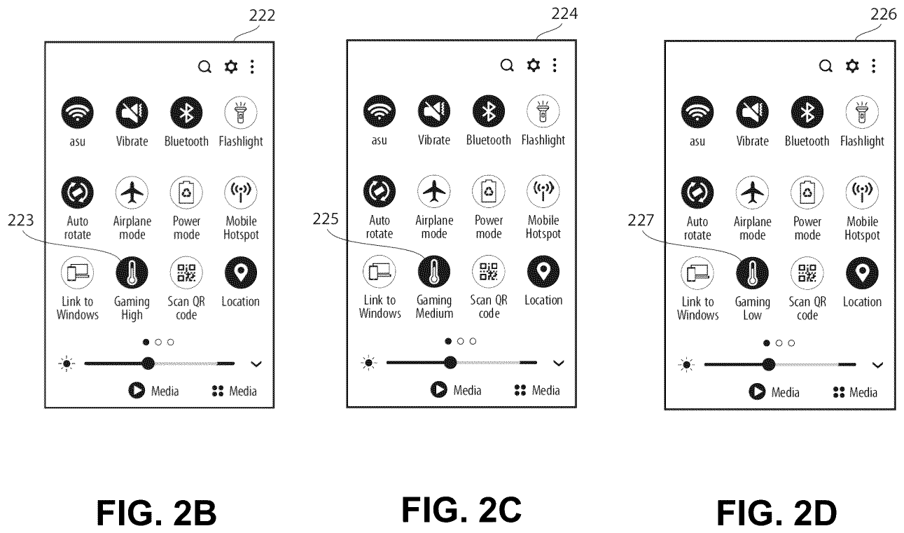

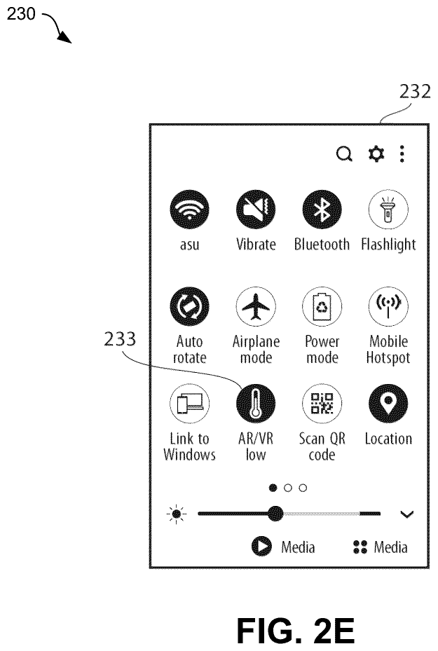

In some aspects, based on a change in context associated with the electronic device 100 (e.g., switching from one usage mode of the electronic device 100 to another mode, such as from an XR mode to a video mode), the thermal management engine 120 can be configured to adjust or set the electronic device 100 to one or more different thermal profiles and/or provide options (and in some cases recommendations) via an interactive graphical user interface for a user to set or update the thermal profile. For instance, in some examples, the thermal management engine 120 can manage a graphical user interface (e.g., as is shown in FIGS. 2A-2E, described below) to enable manual selection and/or automatic selection (e.g., based on a learned history of selection by the user via the graphical user interface) of an updated thermal profile for the electronic device 100. In some examples, the electronic device 100 may have a set of default settings, in which case the thermal management engine 120 can detect a change in context and automatically apply a new thermal profile for the new context, as described herein. In some cases, in the event the thermal management engine 120 automatically selects a thermal profile based on a change in context, the thermal management engine 120 may output a message notifying the user of the change in context and/or of the new thermal profile. In some cases, an interactive object may be displayed for selection by the user to opt out of the thermal profile change. As noted herein, in some aspects, a machine learning or artificial intelligence model can be trained on the various types of user input that can be received and used to classify or determine a context and thus assign anew thermal profile based on the determined context or change in context.

In some cases, the one or more sensors 106 can detect an acceleration, angular rate, and/or orientation of the electronic device 100 and generate measurements based on the detected acceleration or other data. In some cases, the one or more sensors 106 can detect and measure the orientation, linear velocity, and/or angular rate of the electronic device 100. For example, the one or more sensors 106 can measure a movement and/or a pitch, roll, and yaw of the electronic device 100. These various detected configurations can relate to a context which can then be used by the thermal management engine 120 to determine a particular thermal profile to use from the thermal profiles stored in the thermal profile database 122. In some examples, the electronic device 100 can use measurements obtained by the one or more sensors 106 and/or data from one or more of the camera 102 and/or the camera 104, to calculate a pose or orientation of the electronic device 100 within three-dimensional (3D) space. In some cases, the electronic device 100 can additionally or alternatively use sensor data from the camera 102, the camera 104, the one or more sensors 106, and/or any other sensor to perform tracking, pose estimation, mapping, image segmentation, face detection, human detection, scene detection, object detection, image data pre-processing and/or post-processing, and/or other operations as described herein. Any one or more of this data can be provided to the thermal management engine 120. The thermal management engine 120 can use the data to make a determination of whether a context has changed and whether to implement a change in a thermal profile setting based on the change in context. In one illustrative example, the thermal management engine 120 can select a different thermal profile based on a pose of the electronic device 100 changing from being held in the hand to being held next to the user's ear. In another illustrative example, based on image data from the camera 102 and/or the camera 104, the thermal management engine 120 may determine that there are four people in proximity to the electronic device 100 in a room. The thermal management engine 120 may further determine a temperature in the room based on temperature data from a sensor of the one or more sensors 106. The combination of data could be used by the thermal management engine 120 to select a particular thermal profile from the thermal profiles stored in the thermal profile database 122.

In one illustrative example, the thermal management engine 120 can determine a first context associated with the electronic device 100. The first context can relate to a mode of operation, a configuration of the electronic device 100, an application being used, a position of the electronic device 100, any combination thereof, and/or other parameters associated with the electronic device 100. The thermal management engine 120 can set, based on the first context, a first thermal profile stored in the thermal profile database 122. One non-limiting example of the first context can be where the electronic device 100 is being used in a phone call mode, such a user utilizing a telephone application of the electronic device 100 to make a phone call. The user may select a speaker option on the electronic device 100 such that the electronic device 100 could be set on a table and not held up to the ear of the user. The one or more sensors 106 may determine that the electronic device 100 is not in motion and/or is in a particular orientation (e.g., in a horizontal orientation) which may indicate that the device is not held up to the user's ear. The first thermal profile can be appropriate for this first context such that the electronic device 100 may generate a relatively high amount of heat when compared to other contexts, as the electronic device 100 is not in contact or in proximity to the user's body. The amount of heat that is allowed to be generated for the first thermal profile can be based on a temperature threshold that is manually set by the user via a graphical user interface (e.g., one or more of the graphical user interfaces of FIG. 2A-2E) or can be based on a default temperature threshold.

In some cases, the thermal management engine 120 can determine that a change has occurred from the first context to a second context. A non-limiting example of the second context could be that the user has started a new application in which the electronic device 100 is configured to provide a virtual reality (VR) experience and is thus closer to the user's eyes and in a vertical position. In some cases, the one or more sensors 106 may determine that the electronic device 100 is moving and/or is in a particular orientation (e.g., a vertical orientation) that indicates the device 100 may be in use in close proximity to the user's body. Additionally or alternatively, in some cases, image data from the camera 102 and/or the camera 104 may be used by the electronic device 100 to determine a distance of the electronic device 100 to the user's eyes. As noted herein, different body parts (e.g., ear, eyes, hands, etc.) can have different sensitivities to temperature. For example, the eyes may be more sensitive to heat than the hands. Based on the proximity of the electronic device 100 to the user's eyes, the electronic device 100 may automatically or based on user input provided via a graphical user interface determine to change to a second thermal profile (with a lower temperature threshold) which would cause the electronic device 100 to generate less heat as compared to the first thermal profile.

The components shown in FIG. 1 with respect to the electronic device 100 are illustrative examples provided for explanation purposes. In other examples, the electronic device 100 can include more or less components than those shown in FIG. 1. While the electronic device 100 is shown to include certain components, one of ordinary skill will appreciate that the electronic device 100 can include more or fewer components than those shown in FIG. 1. For example, the electronic device 100 can include, in some instances, one or more memory devices (e.g., RAM, ROM, cache, and/or the like), one or more networking interfaces (e.g., wired and/or wireless communications interfaces and the like), one or more display devices, caches, storage devices, and/or other hardware or processing devices that are not shown in FIG. 1. An illustrative example of a computing device and/or hardware components that can be implemented with the electronic device 100 are described below with respect to FIG. 6.

FIG. 2A is a diagram illustrating an example series of graphical user interfaces that can be presented via a display (such as output device 635 in FIG. 6) of the electronic device 100. For example, a settings screen 202 can include a thermal mitigation option 203. The thermal mitigation option 203 can be presented as a selectable object that can be selected by the user by interacting (e.g., clicking, pressing, gesturing, via voice input, etc.) with the settings screen 202. If the user selects the thermal mitigation option 203, a thermal mitigation user interface 204 can be presented on the display with a plurality of options associated with a plurality of contexts associated with the electronic device 100. The plurality of options allow a user to provide user input for selecting a context in which the electronic device 100 will be used. The example options shown include gaming, virtual reality/augmented reality (VR/AR), video/browsing, camera, or idle. Other options are contemplated as well. For example, a thermal history could be presented for selection in addition or as an alternative to any of the options shown as part of the thermal mitigation user interface 204.

When the user selects a particular context (e.g., the AR/VR context option) from the thermal mitigation user interface 204, an example graphical user interface 206 may be presented with plurality of options associated with a plurality of thermal profiles for the selected context. The user can provide user input to select a level of the temperature threshold. The threshold in one example can be low, medium, or high. Other options such as a sliding scale between a lowest temperature and a highest temperature could be presented. In another example, when the user selects the gaming context option, a graphical user interface 208 can be presented in which the temperature threshold for the gaming context can be selected.

In some cases, the user can set different thresholds for different contexts by providing input to one or more of the various user interfaces 202-210. For instance, in some examples, an advanced object 209 can be presented on the graphical user interfaces 206, 208. For instance, if the user selects the advanced object 209 on one of the graphical user interfaces 206 or 208, then an advanced graphical user interface 210 can be presented in which the user can select or enter a particular temperature threshold for the electronic device 100.

In some aspects, the high temperature shown in graphical user interface 210 may be set by a manufacturer of the electronic device 100 according to a temperature threshold associated with hardware components of the electronic device 100 (e.g., based on a value or limit that is harmful to the device circuitry). For example, the high temperature threshold may be set such that the hardware components may be damaged at any temperature above the high temperature threshold. In one example, the maximum temperature threshold can include a maximum temperature junction Tj. In some cases, the graphical user interface 210 is configured such that the high temperature threshold cannot be adjusted by the user.

The electronic device 100 can automatically set or the user of the electronic device 100 can set (e.g., by providing input via one or more of the graphical user interfaces 206, 208, or 210) thresholds and/or temperature ranges for different contexts based on geographic region in which the electronic device 100 is located, time of year (e.g., whether it is summer or winter), location of the electronic device 100 relative to the user, weather reports or predicted temperature at a particular location, any combination thereof, and/or other factors. For example, as described herein, different body parts (e.g., ear, eyes, hands, etc.) can have different sensitivities to temperature and thus the settings may relate to a particular type of body part. In another example, temperature sensitivity to various contexts might vary by region. For instance, in cold regions of the Earth, the thermal profiles may allow for more heat to be generated as compared to hotter regions of the earth. In some aspects, the thermal management engine 120 can adjust thermal profiles stored in the thermal profile database 122 manually or automatically (e.g., via one or more of the user interfaces 206, 208, or 210 shown in FIG. 2A) depending on the location of the electronic device 100. FIG. 2B, FIG. 2C, and FIG. 2D are diagrams illustrating examples of graphical user interfaces 222, 224, and 226 including various selectable objects or applications. Each of the example graphical user interfaces 222, 224, and 226 provide a user selectable quick panel button or object that can be selected to establish a temperature setting for an application. For example, the graphical user interfaces 222, 224, 226 illustrate how the user can change a temperature threshold from a quick panel button or selectable object, which is illustrated as a gaming object (e.g., gaming object 223 in FIG. 2B, gaming object 225 in FIG. 2C, and gaming object 227 in FIG. 2D).

In particular, graphical user interface 222 of FIG. 2B shows a panel of selectable objects for settings for the electronic device 100, including a rotate mode, an airplane mode, and so forth. The graphical user interface 222 also includes a selectable gaming object 223 that relates to a thermal profile for a gaming application. In the graphical user interface 222, the gaming object 223 is set to “high” in terms of its temperature threshold (e.g., the high temperature threshold set via the graphical user interface 208 or 210 of FIG. 2A). The graphical user interface 224 of FIG. 2C and the graphical user interface 226 of FIG. 2D also include gaming object 225 and gaming object 227, respectively. The gaming object 225 in graphical user interface 224 is set to medium (corresponding to a medium temperature threshold and associated thermal mitigation techniques) and the gaming object 227 in graphical user interface 226 is set to low (corresponding to a medium temperature threshold and associated thermal mitigation techniques).

The user can click on the gaming object 223, 225, or 227 to change the thermal profile (and corresponding temperature threshold and associated thermal mitigation techniques), such as when the subject of that object (gaming) is in use by the user. In some examples, the electronic device 100 can be configured such that a click on the gaming object (e.g., gaming object 223, 225, or 227) can transition the temperature threshold between low, medium, and high (or other levels or ranges). For instance, if the temperature threshold for gaming is set to high, the user can click on the gaming object 223 to transition the temperature threshold for gaming to medium (resulting in display of gaming object 225). In some examples, the electronic device 100 can be configured such that a long press (e.g., by holding a finger on a portion of a touchscreen for a threshold length of time) on the gaming object (e.g., gaming object 223, 225, or 227) can transition the graphical user interface to a detailed settings screen, such as the settings screen 202, the graphical user interface 204, the graphical user interface 206, the graphical user interface 208, or the graphical user interface 210 of FIG. 2A. The user can then provide input to one or more of the settings screen 202, the graphical user interface 204, the graphical user interface 206, the graphical user interface 208, or the graphical user interface 210 of FIG. 2A to change or set a temperature threshold for that application. Other types of interactions with the graphical user interfaces 222, 224, or 226 can also be performed to adjust the thermal profile of the gaming application

FIG. 2E is a diagram 230 illustrating an example graphical user interface 232 in which a quick panel button 233 for an augmented reality (AR)/virtual reality (VR) mode can be set to a low temperature threshold. When this mode is set to low and the electronic device 100 is used in the context of AR/VR through a game or other application, the low thermal profile (and corresponding low temperature threshold) is set for the AR/VR context. In some examples, the electronic device 100 can be configured such the user can select the quick panel button 233 related to an AR/VR application to transition the temperature threshold between low, medium, and high (or other levels or ranges). For example, if the temperature threshold for the AR/VR context is set to high, the user can select (e.g., via a press, gesture, etc.) the quick panel button 233 to transition the temperature threshold for the AR/VR context to low (resulting in display of the quick panel button 233). The user may select the quick panel button 233 again to transition the temperature threshold for the AR/VR context from low to medium. In some examples, the electronic device 100 can be configured such that the user can perform a long press on the quick panel button 233 to transition the graphical user interface to a detailed settings screen, such as the settings screen 202, the graphical user interface 204, the graphical user interface 206, the graphical user interface 208, or the graphical user interface 210 of FIG. 2A.

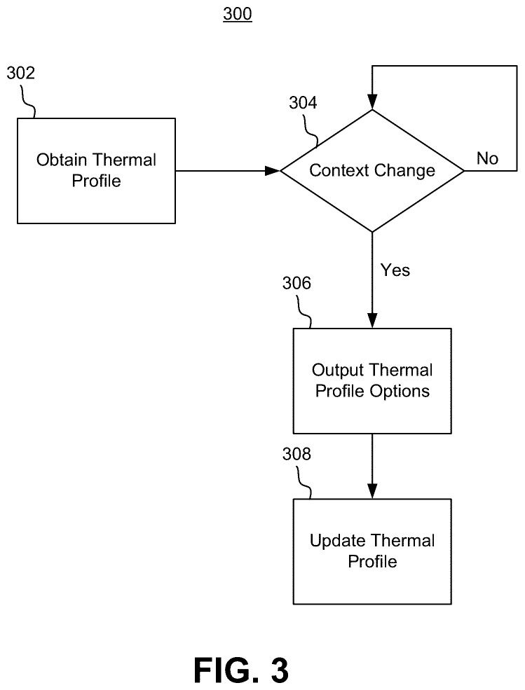

FIG. 3 is a block diagram illustrating an example of a process 300 for updating a thermal profile based on a context. The process 300 can be interactive (e.g., based on user input via a graphical user interface, such as one or more of the graphical user interfaces shown in FIG. 2A-2E) or non-interactive (e.g., based on automatic selection of a thermal profile). At block 302, the process 300 includes obtaining a thermal profile. For example, the electronic device 100 may obtain the thermal profile from a plurality of thermal profiles stored in the thermal profile database 122 shown in FIG. 1. The thermal profile can be configured or have settings specific to the electronic device 100 (e.g., how to modify operation of the compute components 110 and/or which components to use for a given context).

At block 304, the process 300 includes determining whether there is a change in context. For example, as described herein, the thermal management engine 120 may determine that a context change has occurred based on sensor data from sensor(s) 106, camera data from camera 104, location of the electronic device 100 relative to the user, geographic region in which the electronic device 100 is located, etc. At block 306, if a context change is detected at block 306, the process 300 includes outputting, via a graphical user interface on a display of the electronic device 100, options associated with a change in context and/or a change in thermal profile. In one example, the options can allow the user to interact with the graphical user interface as shown in FIGS. 2A-2E to select a new thermal profile and/or temperature threshold, to approve the change in thermal profile, or provide other user input associated with the change in thermal profile.

In some aspects, the manner in which the user interacts with a graphical user interface in connection with changing a thermal profile can occur in phases. For instance, during a first phase, the thermal management engine 120 may take into account user input provided via a graphical user interface (e.g., one or more of the graphical user interfaces shown in FIGS. 2A-2E). In one example, the thermal management engine 120 may receive data based on user selections via the graphical user interface(s). The thermal management engine 120 may learn or identify preferred settings of the user based on one or more thermal profile selections by the user via the graphical user interface(s). Such data can be stored and managed by the thermal management engine 120. For example, a model (e.g., a machine learning model, such as a neural network) can be trained to detect or learn certain patterns of user selection when a particular change in context occurs (e.g., the user always sets the electronic device 100 to a certain thermal profile when a particular context occurs). A second phase may include the thermal management engine 120 automatically making thermal profile selections in response to detection of a particular context change. During the second phase, the options presented via the graphical user interface to the user may include a message or notification indicating a change to a particular thermal profile has occurred. In this scenario, a model can be applied in which the context-change pattern is detected and the thermal management engine 120 automatically sets the thermal profile to the new thermal profile that the user expects or that the user has traditionally set. This multi-phased approach can be more efficient for the user in that the first phase enables the system to learn the preferences of the user which enables the preferred thermal profile to be set without user interaction in the second phase.

At block 308, the process 300 updates the electronic device 100 to (e.g., by selecting or setting) the new thermal profile according to one or more of the change in context, user interaction, or stored preferences that cause the thermal management engine 120 to update the thermal profile.

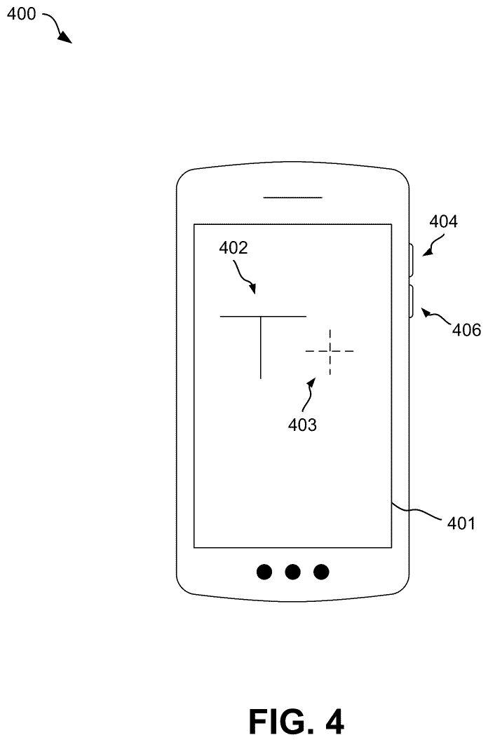

In some aspects, to control the thermal profiles and corresponding temperature thresholds and/or mitigation techniques, a user can perform one or more gestures and/or provide input via one or more software or hardware buttons of the electronic device 400. FIG. 4 is a diagram illustrating an example of an electronic device 400 where input can be provided via an interface 401 and/or hardware buttons 404 and 406 of the electronic device 400. For example, the user can draw a “T” shape 402 to initiate or cause a change to a different thermal mode (associated with a different thermal profile and corresponding temperature threshold). In one illustrative example, the “T” shape 402 can be input by the user by providing a gesture input in the shape of a T (e.g., drawing the “T” shape 402 in a field of view of a camera of the electronic device). In such an example, the electronic device 400 can detect the gesture based on one or more images captured by a camera (not shown) of the electronic device 400. In another illustrative example, the user can draw the “T” shape 402 directly on the interface 401 (which may include a touch interface) of the electronic device 400.

In some cases, such as after drawing the “T” shape 402, the user can press the volume up button 404 to increase the temperature threshold or press the volume down button 406 to decrease the temperature threshold for a current context (e.g., an AR/VR context, a camera context, a video context, etc.). In some examples, the user can provide input to increase or decrease the temperature threshold by selecting one or series of buttons, such as the volume up button 404 and/or the volume down button 406 in a particular sequence. In some aspects, such as after drawing the “T” shape 402, the user can draw (e.g., via a gesture in the field of view of a camera of the electronic device 400 or directly on the touch interface of the electronic device 400) a “+” shape 403 to increase the temperature threshold or a “−” shape (not shown) to decrease the temperature threshold.

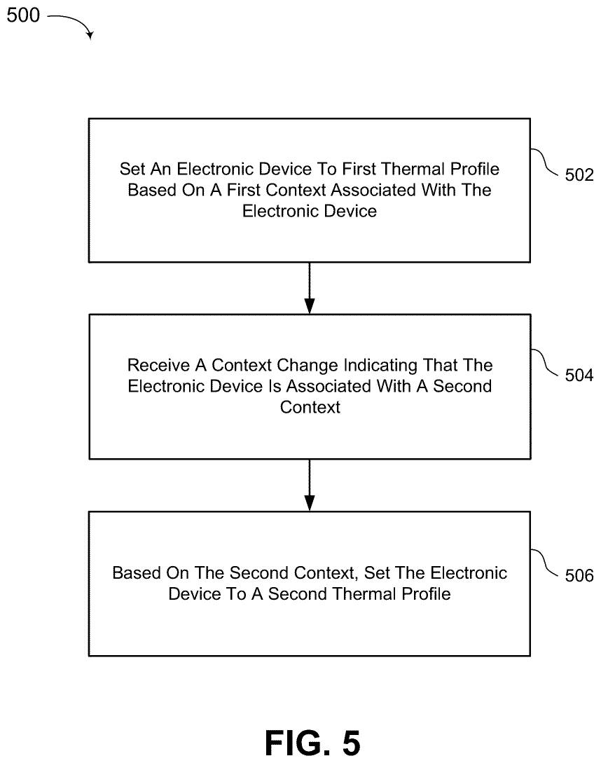

FIG. 5 illustrates an example method for maintaining thermal profiles according to the systems and techniques described herein. The process 500 may be performed by an electronic device, such as a mobile device (e.g., a mobile telephone or other mobile device), a wearable device, an extended reality (XR) device (e.g., a virtual reality (VR) device, an augmented reality (AR) device, or a mixed reality (MR) device), a head-mounted device (HMD) device, a wireless communication device, a camera, a personal computer, a laptop computer, a server computer, a vehicle or a computing device or component of a vehicle, another device, or a combination thereof.

At block 502, the electronic device (or component thereof) may set an electronic device to first thermal profile based on a first context associated with the electronic device. The first context may be associated with one of a cell-phone mode of the electronic device, a gaming mode of the electronic device, an augmented reality mode of the electronic device, a video conferencing mode of the electronic device, or a video mode of the electronic device.

At block 504, the electronic device (or component thereof) may receive a context change indicating that the electronic device is associated with a second context. In some aspects, the context change is set manually based on user input received via a graphical user interface (e.g., the settings screen 202, the graphical user interface 204, the graphical user interface 206, the graphical user interface 208, or the graphical user interface 210). In some cases, the electronic device (or component thereof) may automatically detect the context change (e.g., based on detecting a change from a gaming application to a camera application).

At block 506, the electronic device (or component thereof) may set, based on the second context, the electronic device to a second thermal profile. The second context may be associated with a different one (as compared to the first context) of the cell-phone mode, the gaming mode, the augmented reality mode, the video conferencing mode, and the video mode. In some aspects, the electronic device (or component thereof) may set the electronic device to the second thermal profile further based on user input associated with selection of the second thermal profile.

In some aspects, the electronic device (or component thereof) may output, via a graphical user interface of the electronic device, a plurality of options associated with a plurality of contexts associated with the electronic device. The plurality of contexts in such aspects include at least the first context and the second context. The electronic device (or component thereof) may receive, via the graphical user interface, a first input associated with selection of an option corresponding to the second context. The electronic device (or component thereof) may output, via the graphical user interface based on receiving the first input, a plurality of options associated with a plurality of thermal profiles. In such cases, the plurality of thermal profiles may include at least the first thermal profile and the second thermal profile. The electronic device (or component thereof) may receive, via the graphical user interface, a second input associated with selection of an option corresponding to the second thermal profile. Based on receiving the second input, the electronic device (or component thereof) may then set the electronic device to the second thermal profile.

In some cases, the electronic device (or component thereof) may receive a gesture input from a user via the electronic device. The electronic device (or component thereof) may set, based on the gesture input, the electronic device to a thermal adjustment mode. The electronic device (or component thereof) may receive additional user input via the electronic device while in the thermal adjustment mode. In some examples, the additional user input is received via one or more physical buttons of the electronic device. The electronic device (or component thereof) may then set the electronic device to the second thermal profile further based on the additional user input.

In some aspects, the electronic device (or component thereof) may ouput, via a

graphical user interface of the electronic device based on setting the electronic device to the second thermal profile, a notification indicating a potential change in performance of an application.

In some cases, the electronic device (or component thereof) may select the second thermal profile for the electronic device based on at least one prior selection of the second thermal profile via a graphical user interface. In some examples, the electronic device (or component thereof) may output, via the graphical user interface, a notification indicative of the selection of the second thermal profile for the electronic device.

In some examples, the processes described herein (e.g., the process 300 and the process 500) may be performed by one or more computing devices or apparatuses. For instance, as noted above, the process 500 may be performed by an electronic device (e.g., a mobile device, an XR device, etc.). In one illustrative example, the processes described herein (e.g., the process 300 and/or the process 500) can be performed by the electronic device 100 shown in FIG. 1. In some examples, the processes described herein (e.g., the process 300 and/or the process 500) can be performed by one or more computing devices with the computing device architecture 600 shown in FIG. 6. In some cases, such a computing device or apparatus may include a processor, microprocessor, microcomputer, or other component of a device that is configured to carry out the steps of the process 300 and/or the process 500. In some examples, such computing device or apparatus may include one or more sensors configured to capture image data and/or other sensor measurements. For example, the computing device can include a smartphone, a head-mounted display, an electronic device, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 300 and the process 500 are illustrated as logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 300 and/or the process 500) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 illustrates an example computing device architecture 600 of an example computing device which can implement various techniques described herein. For example, the computing device architecture 600 can implement at least some portions of the electronic device 100 shown in FIG. 1. The components of the computing device architecture 600 are shown in electrical communication with each other using a connection 605, such as a bus. The example computing device architecture 600 includes a processing unit (CPU or processor) 610 and a computing device connection 605 that couples various computing device components including the computing device memory 615, such as read only memory (ROM) 620 and random access memory (RAM) 625, to the processor 610.

The computing device architecture 600 can include a cache of high-speed memory connected directly with, in close proximity to, or integrated as part of the processor 610. The computing device architecture 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other computing device memory 615 may be available for use as well. The memory 615 can include multiple different types of memory with different performance characteristics. The processor 610 can include any general-purpose processor and a hardware or software service stored in storage device 630 and configured to control the processor 610 as well as a special-purpose processor where software instructions are incorporated into the processor design. The processor 610 may be a self-contained system, containing multiple cores or processors, a bus, memory controller, cache, etc. A multi-core processor may be symmetric or asymmetric.

To enable user interaction with the computing device architecture 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art, such as a display, projector, television, speaker device. In some instances, multimodal computing devices can enable a user to provide multiple types of input to communicate with the computing device architecture 600. The communication interface 640 can generally govern and manage the user input and computing device output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof. The storage device 630 can include software, code, firmware, etc., for controlling the processor 610. Other hardware or software modules are contemplated. The storage device 630 can be connected to the computing device connection 605. In one aspect, a hardware module that performs a particular function can include the software component stored in a computer-readable medium in connection with the necessary hardware components, such as the processor 610, connection 605, output device 635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks comprising devices, device components, steps or routines in a method embodied in software, or combinations of hardware and software.

Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. A method of maintaining thermal profiles, comprising: setting an electronic device to first thermal profile based on a first context associated with the electronic device; receiving a context change indicating that the electronic device is associated with a second context; and based on the second context, setting the electronic device to a second thermal profile.

Aspect 2. The method of Aspect 1, wherein the context change is set manually based on user input received via a graphical user interface.

Aspect 3. The method of any of Aspects 1 to 2, wherein setting the electronic device to the second thermal profile is further based on user input associated with selection of the second thermal profile.

Aspect 4. The method of any of Aspects 1 to 3, wherein the context change is automatically detected by the electronic device.

Aspect 5. The method of any of Aspects 1 to 4, further comprising: outputting, via a graphical user interface of the electronic device, a plurality of options associated with a plurality of contexts associated with the electronic device, the plurality of contexts including at least the first context and the second context; and receiving, via the graphical user interface, a first input associated with selection of an option corresponding to the second context.

Aspect 6. The method of Aspect 5, further comprising: outputting, via the graphical user interface based on receiving the first input, a plurality of options associated with a plurality of thermal profiles, the plurality of thermal profiles including at least the first thermal profile and the second thermal profile; receiving, via the graphical user interface, a second input associated with selection of an option corresponding to the second thermal profile; and based on receiving the second input, setting the electronic device to the second thermal profile.

Aspect 7. The method of any of Aspects 1 to 6, further comprising: receiving a gesture input from a user via the electronic device; based on the gesture input, setting the electronic device to a thermal adjustment mode; receiving additional user input via the electronic device while in the thermal adjustment mode; and setting the electronic device to the second thermal profile further based on the additional user input.

Aspect 8. The method of Aspect 7, wherein the additional user input is received via one or more physical buttons of the electronic device.

Aspect 9. The method of any of Aspects 1 to 8, further comprising: via a graphical user interface of the electronic device, a notification indicating a potential change in performance of an application.

Aspect 10. The method of any of Aspects 1 to 9, wherein the first context is associated with one of a cell-phone mode of the electronic device, a gaming mode of the electronic device, an augmented reality mode of the electronic device, a video conferencing mode of the electronic device, or a video mode of the electronic device, and wherein the second context is associated with a different one of the cell-phone mode, the gaming mode, the augmented reality mode, the video conferencing mode, and the video mode.

Aspect 11. The method of any of Aspects 1 to 10, further comprising: selecting the second thermal profile for the electronic device based on at least one prior selection of the second thermal profile via a graphical user interface.

Aspect 12. The method of Aspect 11, further comprising: outputting, via the graphical user interface, a notification indicative of the selection of the second thermal profile for the electronic device.

Aspect 13. An apparatus for maintaining thermal profiles, comprising: at least one memory; and at least one processor coupled to at least one memory and configured to: set the apparatus to first thermal profile based on a first context associated with the apparatus; receive a context change indicating that the apparatus is associated with a second context; and based on the second context, set the apparatus to a second thermal profile.

Aspect 14. The apparatus of Aspect 13, wherein the context change is set manually based on user input received via a graphical user interface.

Aspect 15. The apparatus of any of Aspects 13 to 14, wherein the at least one processor is configured to set the apparatus to the second thermal profile further based on user input associated with selection of the second thermal profile.

Aspect 16. The apparatus of any of Aspects 13 to 15, wherein the at least one processor is configured to automatically detect the context change.

Aspect 17. The apparatus of any of Aspects 13 to 16, wherein the at least one processor is configured to: output, via a graphical user interface, a plurality of options associated with a plurality of contexts associated with the apparatus, the plurality of contexts including at least the first context and the second context; and receive, via the graphical user interface, a first input associated with selection of an option corresponding to the second context.

Aspect 18. The apparatus of Aspect 17, wherein the at least one processor is configured to: output, via the graphical user interface based on receiving the first input, a plurality of options associated with a plurality of thermal profiles, the plurality of thermal profiles including at least the first thermal profile and the second thermal profile; receive, via the graphical user interface, a second input associated with selection of an option corresponding to the second thermal profile; and base on receiving the second input, set the apparatus to the second thermal profile.

Aspect 19. The apparatus of any of Aspects 13 to 18, wherein the at least one processor is configured to: receive a gesture input of a user; based on the gesture input, set the apparatus to a thermal adjustment mode; receive additional user input of the user while in the thermal adjustment mode; and set the apparatus to the second thermal profile further based on the additional user input.

Aspect 20. The apparatus of Aspect 19, wherein the additional user input is received via one or more physical buttons of the apparatus.

Aspect 21. The apparatus of any of Aspects 13 to 20, wherein the at least one processor is configured to: based on setting the apparatus to the second thermal profile, output, via a graphical user interface, a notification indicating a potential change in performance of an application.

Aspect 22. The apparatus of any of Aspects 13 to 21, wherein the first context is associated with one of a cell-phone mode of the apparatus, a gaming mode of the apparatus, an augmented reality mode of the apparatus, a video conferencing mode of the apparatus, or a video mode of the apparatus, and wherein the second context is associated with a different one of the cell-phone mode, the gaming mode, the augmented reality mode, the video conferencing mode, and the video mode.

Aspect 23. The apparatus of any of Aspects 13 to 22, wherein the at least one processor is configured to: select the second thermal profile for the apparatus based on at least one prior selection of the second thermal profile via a graphical user interface.

Aspect 24. The apparatus of any of Aspects 13 to 23, wherein the at least one processor is configured to: output, via the graphical user interface, a notification indicative of the selection of the second thermal profile for the apparatus.

Aspect 25. A non-transitory computer-readable medium of a computing device having stored thereon instructions that, when executed by one or more processors, cause the one or more processors to perform operations according to any of Aspects 1 to 24.

Aspect 26. An apparatus for maintaining thermal profiles, the apparatus comprising one or more means for performing operations according to any of Aspects 1 to 24.

1. A method of maintaining thermal profiles, comprising:
determining a first thermal profile for a first application, the first thermal profile including one or more first thermal mitigation techniques to meet a first temperature threshold for the first application;
determining a second thermal profile for a second application, the second thermal profile including one or more second thermal mitigation techniques to meet a second temperature threshold for the second application;
setting an electronic device to the first thermal profile of the first application based on a determination that the first application is being executed by the electronic device;
performing the one or more first thermal mitigation techniques associated with the first thermal profile to cause the electronic device to meet the first temperature threshold associated with the first thermal profile of the first application;
determining a context change based on a transition of the electronic device to execution of a second application;
based on the determined context change, setting the electronic device to the second thermal profile of the second application; and
performing the one or more second thermal mitigation techniques associated with the second thermal profile to cause the electronic device to meet the second temperature threshold associated with the second thermal profile of the second application.

2. The method of claim 1, wherein the context change is set manually based on user input received via a graphical user interface.

3. The method of claim 1, wherein setting the electronic device to the second thermal profile is further based on user input associated with selection of the second thermal profile.

4. The method of claim 1, wherein the context change is automatically detected by the electronic device.

5. The method of claim 1, further comprising:
outputting, via a graphical user interface of the electronic device, a plurality of options associated with a plurality of applications associated with the electronic device, the plurality of applications including at least the first application and the second application; and
receiving, via the graphical user interface, a first input associated with selection of an option corresponding to the second application.

6. The method of claim 5, further comprising:
outputting, via the graphical user interface based on receiving the first input, a plurality of options associated with a plurality of thermal profiles, the plurality of thermal profiles including at least the first thermal profile and the second thermal profile;
receiving, via the graphical user interface, a second input associated with selection of an option corresponding to the second thermal profile; and
based on receiving the second input, setting the electronic device to the second thermal profile.

7. The method of claim 1, further comprising:
receiving a gesture input from a user via the electronic device;
based on the gesture input, setting the electronic device to a thermal adjustment mode;
receiving additional user input via the electronic device while in the thermal adjustment mode; and
setting the electronic device to the second thermal profile further based on the additional user input.

8. The method of claim 7, wherein the additional user input is received via one or more physical buttons of the electronic device.

9. The method of claim 1, further comprising:
based on setting the electronic device to the second thermal profile, outputting, via a graphical user interface of the electronic device, a notification indicating a potential change in performance of an application.

10. The method of claim 1, wherein the first application is associated with one of a cell-phone mode of the electronic device, a gaming mode of the electronic device, an augmented reality mode of the electronic device, a video conferencing mode of the electronic device, or a video mode of the electronic device, and wherein the second application is associated with a different one of the cell-phone mode, the gaming mode, the augmented reality mode, the video conferencing mode, and the video mode.

11. The method of claim 1, further comprising:
selecting the second thermal profile for the electronic device based on at least one prior selection of the second thermal profile via a graphical user interface.

12. The method of claim 11, further comprising:
outputting, via the graphical user interface, a notification indicative of the selection of the second thermal profile for the electronic device.

13. An apparatus for maintaining thermal profiles, comprising:
at least one memory; and
at least one processor coupled to at least one memory and configured to:
determine a first thermal profile for a first application, the first thermal profile including one or more first thermal mitigation techniques to meet a first temperature threshold for the first application;
determine a second thermal profile for a second application, the second thermal profile including one or more second thermal mitigation techniques to meet a second temperature threshold for the second application;
set the apparatus to the first thermal profile of the first application based on a determination that the first application is being executed by the apparatus;
perform the one or more first thermal mitigation techniques associated with the first thermal profile to cause the apparatus to meet the first temperature threshold associated with the first thermal profile of the first application;
determine a context change based on a transition of the apparatus to execution of a second application;
based on the determined context change, set the apparatus to the second thermal profile of the second application; and
perform the one or more second thermal mitigation techniques associated with the second thermal profile to cause the apparatus to meet the second temperature threshold associated with the second thermal profile of the second application.

14. The apparatus of claim 13, wherein the context change is set manually based on user input received via a graphical user interface.

15. The apparatus of claim 13, wherein the at least one processor is configured to set the apparatus to the second thermal profile further based on user input associated with selection of the second thermal profile.

16. The apparatus of claim 13, wherein the at least one processor is configured to automatically detect the context change.

17. The apparatus of claim 13, wherein the at least one processor is configured to:
output, via a graphical user interface, a plurality of options associated with a plurality of applications associated with the apparatus, the plurality of applications including at least the first application and the second application; and
receive, via the graphical user interface, a first input associated with selection of an option corresponding to the second application.

18. The apparatus of claim 17, wherein the at least one processor is configured to:
output, via the graphical user interface based on receiving the first input, a plurality of options associated with a plurality of thermal profiles, the plurality of thermal profiles including at least the first thermal profile and the second thermal profile;
receive, via the graphical user interface, a second input associated with selection of an option corresponding to the second thermal profile; and
base on receiving the second input, set the apparatus to the second thermal profile.

19. The apparatus of claim 13, wherein the at least one processor is configured to:
receive a gesture input of a user;
based on the gesture input, set the apparatus to a thermal adjustment mode;
receive additional user input of the user while in the thermal adjustment mode; and
set the apparatus to the second thermal profile further based on the additional user input.

20. The apparatus of claim 19, wherein the additional user input is received via one or more physical buttons of the apparatus.

21. The apparatus of claim 13, wherein the at least one processor is configured to:
based on setting the apparatus to the second thermal profile, output, via a graphical user interface, a notification indicating a potential change in performance of an application.

22. The apparatus of claim 13, wherein the first application is associated with one of a cell-phone mode of the apparatus, a gaming mode of the apparatus, an augmented reality mode of the apparatus, a video conferencing mode of the apparatus, or a video mode of the apparatus, and wherein the second application is associated with a different one of the cell-phone mode, the gaming mode, the augmented reality mode, the video conferencing mode, and the video mode.

23. The apparatus of claim 13, wherein the at least one processor is configured to:
select the second thermal profile for the apparatus based on at least one prior selection of the second thermal profile via a graphical user interface.

24. The apparatus of claim 23, wherein the at least one processor is configured to:
output, via the graphical user interface, a notification indicative of the selection of the second thermal profile for the apparatus.

25. A non-transitory computer-readable medium of an electronic device having stored thereon instructions that, when executed by one or more processors, cause the one or more processors to:
determine a first thermal profile for a first application, the first thermal profile including one or more first thermal mitigation techniques to meet a first temperature threshold for the first application;
determine a second thermal profile for a second application, the second thermal profile including one or more second thermal mitigation techniques to meet a second temperature threshold for the second application;
set the electronic device to the first thermal profile of the first application based on a determination that the first application is being executed by the electronic device;
perform the one or more first thermal mitigation techniques associated with the first thermal profile to cause the electronic device to meet the first temperature threshold associated with the first thermal profile of the first application;
determine a context change based on a transition of the electronic device to execution of a second application;
based on the determined context change, set the electronic device to a second thermal profile of the second application; and
perform the one or more second thermal mitigation techniques associated with the second thermal profile to cause the electronic device to meet the second temperature threshold associated with the second thermal profile of the second application.

26. The non-transitory computer-readable medium of claim 25, wherein the context change is set manually based on user input received via a graphical user interface.

27. The non-transitory computer-readable medium of claim 25, further comprising instructions that, when executed by the one or more processors, cause the one or more processors to set the electronic device to the second thermal profile further based on user input associated with selection of the second thermal profile.

28. The non-transitory computer-readable medium of claim 25, further comprising instructions that, when executed by the one or more processors, cause the one or more processors to automatically detect the context change.

29. The non-transitory computer-readable medium of claim 25, further comprising instructions that, when executed by the one or more processors, cause the one or more processors to:
output, via a graphical user interface, a plurality of options associated with a plurality of applications associated with the electronic device, the plurality of applications including at least the first application and the second application; and
receive, via the graphical user interface, a first input associated with selection of an option corresponding to the second application.

30. The non-transitory computer-readable medium of claim 25, further comprising instructions that, when executed by the one or more processors, cause the one or more processors to:
receive a gesture input of a user;
based on the gesture input, set the electronic device to a thermal adjustment mode;
receive additional user input of the user while in the thermal adjustment mode; and
set the electronic device to the second thermal profile further based on the additional user input.
